(19) United States
(12) Patent Application Publication
(10) Pub. No.: US 2021/0110321 A1
(43) Pub. Date: Apr. 15, 2021

(54) DISPLAY DEVICE AND METHOD FOR CONTROLLING DISPLAY DEVICE

(71) Applicant: NEC CORPORATION, Tokyo (JP)

(72) Inventors: Hiroshi Tezuka, Tokyo (JP); Masaharu Kuroda, Tokyo (JP)

(73) Assignee: NEC CORPORATION, Tokyo (JP)

(21) Appl. No.: 16/569,766

(22) Filed: Sep. 13, 2019

Related U.S. Application Data
(63) Continuation of application No. 15/035,538, filed on May 10, 2016, now abandoned.

(30) Foreign Application Priority Data
Nov. 14, 2013 (JP) 2013-235778

(51) Int. Cl. G06Q 10/06; G06Q 30/02

(52) U.S. Cl. CPC G06Q 10/0637; G06Q 30/0251

(57) ABSTRACT

A display device includes a display device and a processor. The processor estimates, based on prediction information enabling a prediction of a visiting state and identification information enabling unique identification of a person, the visiting state of the person identified by the identification information, and transmits, at a time when the person is estimated to visit a location based on the estimated visiting state of the person, the identification information to a terminal, wherein the identification information comprises authentication data for personal authentication of the person identified by the identification information.

### TECHNICAL FIELD

The present invention relates to a customer information management device, a store terminal, a customer information management method, and a program.

### BACKGROUND ART

A point of sale (POS) system has been provided that achieves a POS register function using a general-purpose portable terminal such as a tablet computer (PC) in place of a conventional POS register terminal. The POS system is also referred to as a mobile POS system. According to the mobile POS system, advantages are offered that not only allow the initial cost to be reduced, but also allow the administrator on the store side to perform sales management, sales analysis, and the like without dependence on the location or time by linking with cloud services.

Various services have been provided in the POS system. The following electronic coupon system has been proposed in the following Patent Document 1. A portable information terminal transmits a customer ID and an own portable information terminal ID, which are read from a customer card, to a store server when entering a store, and the store server matches the customer ID and the portable information terminal ID with each other. A store information terminal transmits the read customer ID, the own portable information terminal ID, and the content ID of a coupon target which is being displayed to the store server by the customer card being held over the store information terminal. The store server then provides coupon information, which is acquired from a coupon information database based on the content ID, to the portable information terminal matched with the customer ID.

### RELATED DOCUMENT

### Patent Document

[Patent Document 1] Japanese Unexamined Patent Application Publication No. 2007-213276

### SUMMARY OF THE INVENTION

In the configuration of exchanging information between the server and the store terminal as in Patent Document 1 described above, business is stopped in a case in which the network is disconnected. In particular, in a mobile POS system, a store terminal performs an operation, such as register processing, mainly using the information managed by the server. Accordingly, the degree of influence on business if the network is disconnected is high.

It is an object of the present invention to provide a technique for reducing the influence of a communication environment on customer services in a system in which customer services are offered using customer information transmitted to a store terminal from a customer information management device.

According to the present invention, there is provided a customer information management device including: a store visit estimation unit that estimates, based on store visit prediction information enabling prediction of a customer's store visiting state and customer identification information enabling unique identification of the customer, the store visiting state of the customer identified by the customer identification information; and a customer information transmission unit that transmits, when the customer's visiting state is estimated, the customer identification information and customer information to a store terminal, the customer information being relevant to the customer identified by the customer identification information.

According to the present invention, there is provided a store terminal communicably connected to the customer information management device described above. The store terminal includes: an acquisition unit that acquires the customer identification information and the customer information transmitted from the customer information management device; a storage unit that stores the acquired customer identification information and the acquired customer information in association with each other; a detection unit that detects at least one of use of the customer information, passage of a predetermined amount of time from the acquisition of the customer information, and the customer's leaving of the store; and an execution unit that executes predetermined processing relevant to the customer information or to customer information which is associated with the customer identification information corresponding to the customer, based on a detection result of the detection unit.

According to the present invention, there is provided a customer information management method performed by a computer including: estimating, based on store visit prediction information enabling prediction of a customer's store visiting state and customer identification information enabling unique identification of the customer, the store visiting state of the customer identified by the customer identification information; and transmitting, when the customer's visiting state is estimated, the customer identification information and customer information to a store terminal, the customer information being relevant to the customer identified by the customer identification information.

According to the present invention, there is provided a customer information management method performed by a computer which is communicably connected to the customer information management device described above, including: acquiring the customer identification information and the customer information transmitted from the customer information management device; storing the acquired customer identification information and the acquired customer information in association with each other; detecting at least one of use of the customer information, passage of a predetermined amount of time from the acquisition of the customer information, and the customer's leaving of the store; and executing predetermined processing relevant to the customer information or to customer information which is associated with the customer identification information corresponding to the customer, based on a result of the detection.

According to the present invention, there is provided a program causing a computer to function as: a store visit estimation unit that estimates, based on store visit prediction information enabling prediction of a customer's store visiting state and customer identification information enabling unique identification of the customer, the store visiting state of the customer identified by the customer identification information; and a customer information transmission unit that transmits, when the customer's visiting state is estimated, the customer identification information and customer information to a store terminal, the customer information being relevant to the customer identified by the customer identification information.

According to the present invention, there is provided a program causing a computer communicably connected to the customer information management device described above to function as: an acquisition unit that acquires the customer identification information and the customer information transmitted from the customer information management device; a storage unit that stores the acquired customer identification information and the acquired customer information in association with each other; a detection unit that detects at least one of use of the customer information, passage of a predetermined amount of time from the acquisition of the customer information, and the customer's leaving of the store; and an execution unit that executes predetermined processing relevant to the customer information or to customer information which is associated with the customer identification information corresponding to the customer, based on a detection result of the detection unit.

According to the present invention, it is possible to reduce the influence of a communication environment on customer services in a system offering customer services using the customer information transmitted to the store terminal from the customer information management device.

### BRIEF DESCRIPTION OF THE DRAWINGS

The above-described object and other objects, features, and advantages will become more apparent by preferred exemplary embodiments described below and the following accompanying diagrams.

FIG. 1 is a block diagram conceptually showing an example of the processing configuration of a customer information management device in a first exemplary embodiment of the present invention.

FIG. 2 is a diagram showing an example of the store visit certainty degree score.

FIG. 3 is a block diagram schematically showing an example of the processing configuration of a customer information management system.

FIG. 4 is a diagram illustrating a specific operation example of an execution unit.

FIG. 5 is a diagram conceptually showing an example of the configuration of a POS system in the present invention.

FIG. 6 is a diagram conceptually showing an example of the hardware configuration of the customer information management device.

FIG. 7 is a flowchart showing the flow of the process of the customer information management device in the first exemplary embodiment.

FIG. 8 is a flowchart showing the flow of the process of a store terminal in the first exemplary embodiment.

FIG. 9 is a flowchart showing the flow of the process of a customer information management device in a second exemplary embodiment.

FIG. 10 is a diagram showing an example of the spending likelihood score.

FIG. 11 is a flowchart showing the flow of the process of a customer information management device in a third exemplary embodiment.

FIG. 12 is a diagram conceptually showing the configuration of a POS system in an example of the present invention.

### DESCRIPTION OF EXEMPLARY EMBODIMENTS

Hereinafter, an exemplary embodiment of the present invention will be described with reference to the accompanying diagrams. In addition, the same components are denoted by the same reference numerals in all diagrams, and the explanation thereof will not be repeated.

### First Exemplary Embodiment

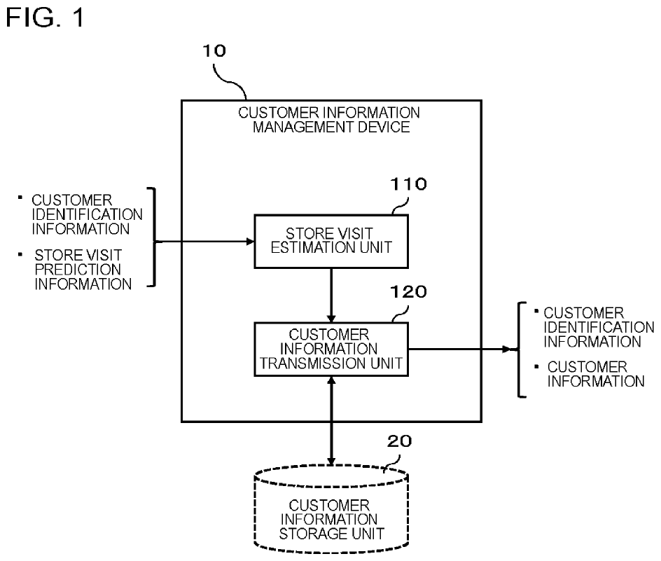

FIG. 1 is a block diagram conceptually showing an example of the processing configuration of a customer information management device 10 in a first exemplary embodiment of the present invention. As shown in FIG. 1, the customer information management device 10 includes a store visit estimation unit 110 and a customer information transmission unit 120.

The store visit estimation unit 110 estimates the store visiting state of a customer identified by customer identification information based on store visit prediction information that enables the prediction of the customer's store visiting state and the customer identification information that enables the unique identification of the customer.

Here, the “store visit prediction information” includes at least one of the position information of the customer, store identification information for identifying a store that the customer is visiting, and use declaration information indicating the intention of the customer to use a coupon. However, the store visit prediction information is not limited to the above information as long as it is possible to predict the customer's store visiting state.

As the position information of the customer, for example, position information of the customer terminal obtained from an access point of a global positioning system (GPS) or a wireless local area network (LAN) or position information obtained by a check-in function of a social networking service (SNS) can be used. For example, the position information of the customer may be directly acquired from the customer terminal or the like by the store visit estimation unit 110, or may be acquired by another device communicably connected to the customer information management device 10 and be transmitted to the store visit estimation unit 110. The store visit estimation unit 110, from a position corresponding to the position information of the customer. In addition, the “position information of the customer” is not limited to the examples described above as long as the “position information of the customer” is information through which the position of the customer can be checked.

In addition, position information obtained from the GPS or the check-in function of the SNS is linked to customer identification information indicating the customer terminal or the customer him/herself corresponding to the position information. Therefore, the store visit estimation unit 110 can acquire such position information, and can acquire the customer identification information. For example, information indicating the customer terminal corresponding to the position information can be acquired from the position information obtained from the access point of the GPS or the wireless LAN. In addition, if the correspondence relationship between the customer terminal and the customer is stored in advance in a storage region, the store visit estimation unit 110 can identify the customer from the information indicating the customer terminal. From the position information obtained from the check-in function, for example, it is possible to acquire information such as a user account indicating the customer him/herself. In addition, the store visit estimation unit 110 can identify the customer from the information indicating the customer him/herself. Thus, the store visit estimation unit 110 can acquire the information indicating the customer terminal or the customer him/herself as customer identification information.

The store visit estimation unit 110 can estimate which store the customer is visiting based on the acquired position information. For example, the store visit estimation unit 110 can estimate a store located within a predetermined range from the position corresponding to the acquired position information of the customer as the store that the customer is visiting. In a case in which a plurality of stores are present within the predetermined range, the store visit estimation unit 110 can estimate the store closest to the acquired position information of the customer as the store that the customer is visiting. In addition, the store visit estimation unit 110 can estimate which customer is visiting the store using the acquired customer identification information.

For example, the store identification information can be generated based on information obtained using SHOPKICK® or the like. Specifically, in a case in which there is a customer in a store where a SHOPKICK® device is installed, a response signal is transmitted from the customer terminal with respect to ultrasonic waves transmitted from the device. Then, when the response signal is detected, the SHOPKICK® device can determine that the customer, who is the user of the customer terminal that has transmitted the response signal, is visiting the store where the device is installed. Here, if it is monitored in which store the SHOPKICK® device has detected the response signal, it is possible to generate store identification information in response to the detection of the response signal. The store visit estimation unit 110 can acquire information regarding the customer terminal that has transmitted the response signal to the SHOPKICK® device as customer identification information linked to the position information. For example, the store identification information and the customer identification information may be generated by the store visit estimation unit 110, or may be generated by another device communicably connected to the customer information management device 10 and be transmitted to the store visit estimation unit 110. The store identification information is not limited to the examples described above as long as the store identification information is information through which it is possible to recognize that a certain customer is visiting the store.

For example, the store identification information can be generated based on the position information of the customer obtained from the access point or the like of the GPS or the wireless LAN. Specifically, the store identification information can be generated by determining a store, which is present within a predetermined range from the position indicated by the position information, as a “store that the customer is visiting” or a “store that the customer may be visiting”. As previously described, the store visit estimation unit 110 can also acquire the customer identification information linked to the position information.

The store visit estimation unit 110 can estimate which store the customer is visiting based on the acquired store identification information. In addition, the store visit estimation unit 110 can estimate which customer is visiting the store using the acquired customer identification information.

The “use declaration information” is generated based on the input from the customer terminal, for example. Specifically, a customer selects or inputs a coupon desired to be used in the customer terminal or the like, and as a result, use declaration information including coupon information corresponding to the selected or input coupon is generated. Then, the generated use declaration information is transmitted to the store visit estimation unit 110. In this case, the store visit estimation unit 110 can also acquire customer identification information from the customer terminal together with the use declaration information. In a case in which the use declaration information is generated using the customer terminal, the store visit estimation unit 110 can acquire the customer identification information by acquiring information unique to the customer terminal, such as a serial number of the customer terminal, and transmitting the information together with the use declaration information. If the correspondence relationship between the customer identification number and the customer is stored in advance in a storage region (not shown), the store visit estimation unit 110 can specify the customer corresponding to the acquired customer identification number using the correspondence relationship stored in the storage unit.

The store visit estimation unit 110 can estimate which store the customer is visiting based on the acquired use declaration information. Specifically, the store visit estimation unit 110 can estimate which store the customer is visiting, for example, by referring to information, which indicates a store where a coupon, declared to be used by the use declaration information, can be used and which is linked to the coupon information of the coupon. The coupon information and the information indicating the store where the coupon can be used are stored in a coupon information storage unit (not shown) that stores coupon information. The coupon information storage unit may be provided in the customer information management device 10, or may be provided in another device communicably connected to the customer information management device 10. In addition, the store visit estimation unit 110 can estimate which customer is visiting the store using the acquired customer identification information.

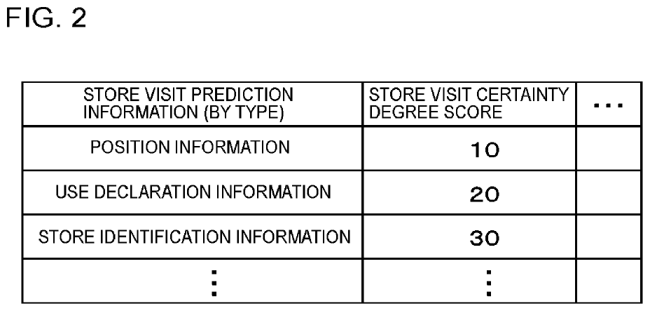

Each type of the store visit prediction information has a store visit certainty degree score linked thereto, and the store visit estimation unit 110 may estimate the store visiting state of each customer using the store visit certainty degree score. Here, the “store visit certainty degree score” is an index value indicating the degree of certainty that the customer is visiting the store. For example, the “store visit certainty degree score” may be expressed with a simple numerical value as shown in FIG. 2, or may be expressed with a probability. FIG. 2 is a diagram showing an example of the store visit certainty degree score. As shown in FIG. 2, the type of store visit prediction information and the store visit certainty degree score corresponding to the type of the store visit prediction information are linked to each other. For example, the store visit estimation unit 110 stores a table such as shown in FIG. 2, and acquires a store visit certainty degree score linked to the acquired store visit prediction information using the table. In the example shown in FIG. 2, from the store identification information generated from SHOPKICK® or the like, the degree of certainty with which it can be determined that the customer is visiting the store is high. Accordingly, the score is set to be high. On the other hand, for the position information obtained from the GPS or the access point, the score is set to be low since a case of simply passing nearby is also considered. FIG. 2 is only an example, and the setting of the store visit certainty degree score is not limited to FIG. 2.

Specifically, the store visit estimation unit 110 estimates the customer's store visiting state according to whether or not the store visit certainty degree score linked to the acquired store visit prediction information is equal to or greater than a predetermined threshold value. The store visit estimation unit 110 can also estimate the customer's store visiting state by summing up store visit certainty degree scores linked to a plurality of pieces of the acquired store visit prediction information and comparing the sum of the store visit certainty degree scores with a predetermined threshold value.

In a case in which the visit of the customer is estimated by the store visit estimation unit 110, the customer information transmission unit 120 transmits customer identification information and customer information relevant to the customer identified by the customer identification information.

Specifically, the customer information transmission unit 120 acquires customer information to be transmitted from a customer information storage unit 20 using the customer identification information acquired by the store visit estimation unit 110, and transmits the customer information to the store terminal together with the customer identification information at a timing corresponding to the visiting state estimated by the store visit estimation unit 110. The customer information storage unit 20 stores information regarding the customer identified by the customer identification information so as to match the customer identification information.

The “timing” referred to herein may be the same as the timing at which the visit of a certain customer is estimated by the store visit estimation unit 110, or may be a timing set with a predetermined interval from the estimated timing. In addition, the “timing” may be a timing estimated that a certain customer will visit the store in the future by the store visit estimation unit 110, or may be a timing at which the visit of the customer is predicted, or may be a timing set with a predetermined interval from the estimated visit timing. This timing can also be said to be a “timing at which a possibility that the customer information is required in the store terminal becomes high to a certain degree”.

The “customer information” is information of the customer that is used at the time of customer service by a store terminal 40. For example, the “customer information” includes at least one of authentication data for personal authentication (for example, authentication data used as correct answer data) of the customer identified by the customer identification information and coupon information available for the customer identified by the customer identification information. Here, the customer information is not limited to such information as long as the customer information is information regarding a customer. For example, the customer information may be membership information for identifying the member of the membership-based store.

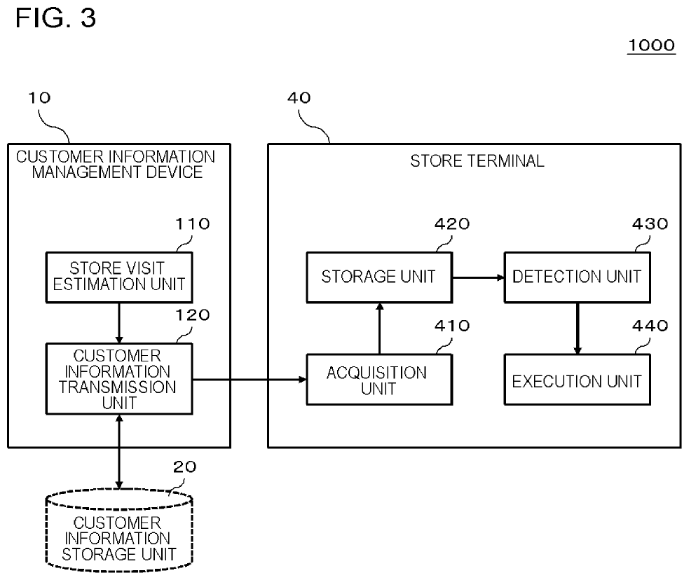

A customer information management system 1000 using the customer information management device 10 in the first exemplary embodiment of the present invention will be described with reference to FIG. 3. FIG. 3 is a block diagram schematically showing an example of the processing configuration of the customer information management system 1000. As shown in FIG. 3, the customer information management system 1000 includes the customer information management device 10 and the store terminal 40. For example, the store terminal 40 may be a smartphone or a portable tablet terminal, or may be a stationary general-purpose computer.

As shown in FIG. 3, the store terminal 40 includes an acquisition unit 410, a storage unit 420, a detection unit 430, and an execution unit 440.

The acquisition unit 410 acquires customer identification information and customer information that are transmitted from the customer information management device 10.

The storage unit 420 stores the customer identification information and the customer information acquired by the acquisition unit 410 in a storage region (not shown), such as a memory or a hard disk, in association with each other.

The detection unit 430 detects at least one of the use of the acquired customer information, the passage of a predetermined amount of time from the acquisition of the customer information, and the customer's leaving of the store.

Here, when the customer information is “coupon information”, “use of customer information” means use of a coupon in the payment processing, and when the customer information is “authentication data”, “use of customer information” means use of authentication data in personal authentication in a credit card payment or the like, for example. A notification of the “use of customer information” is sent to the detection unit 430, for example, when the payment processing of the customer is performed. In addition, coupon information is not particularly limited as long as the coupon information is information regarding a coupon. For example, the coupon information may be an electronic coupon itself, or may be identification information for unique identification of an electronic coupon or a printed coupon. In addition, authentication data is not particularly limited as long as the authentication data is data handled in personal authentication. For example, the authentication data may be a common password, or may be biometric data that is used in biometrics, such as face recognition or fingerprint authentication.

The “predetermined amount of time from the acquisition of customer information” may be set to any value. For example, an average period of time of customers' visits the store or an average period of time from entering the store until payment of customers can be counted, and the average value or the intermediate value that can be calculated from the counted value can be set as the “predetermined amount of time from the acquisition of customer information”. In addition, the “predetermined amount of time from the acquisition of customer information” may be set to a predetermined value determined by the user. Using the value set in this manner, the detection unit 430 detects the “passage of a predetermined amount of time from the acquisition of customer information”.

The customer's visiting or leaving of a store can be detected, for example, by installing a device or the like for acquiring customer identification information in the entrance of the store. The detection unit 430 can receive a customer identification number acquired by the device, and detect “the customer's leaving of the store” from the number of times of detection of each customer identification number or the like. The device itself for acquiring customer identification information may be the detection unit 430. The detection unit 430 can also detect the “customer's leaving of the store” according to the distance between a position corresponding to the position information of the customer obtained from the GPS or the check-in information of the SNS and the position of the store. For example, in a case in which the distance between the position corresponding to the position information of the customer and a predetermined position of the store (for example, the position of the main entrance of the store or the center position of the store) exceeds a predetermined threshold value, the detection unit 430 can determine that the customer corresponding to the position information has left the store. In addition, in a case in which a response signal from the customer terminal is no longer detected by the device for SHOPKICK®, the detection unit 430 can determine that the customer corresponding to the customer terminal has left the store.

The execution unit 440 executes predetermined processing relevant to the customer information based on the detection result of the detection unit 430. Specifically, the execution unit 440 executes predetermined processing relevant to the customer information or to customer information which is associated with the customer identification information corresponding to the customer at a timing corresponding to at least one of the use of the acquired customer information, the passage of a predetermined amount of time from the acquisition of customer information, and the customer's leaving of the store that has been detected by the detection unit 430.

The “timing” referred to herein may be the same as the timing at which at least one of the use of customer information, the passage of a predetermined amount of time from the acquisition of customer information, and the customer's leaving of the store is detected by the detection unit 430, or may be a timing set at a predetermined interval from the detected timing. This timing can also be said to be a “timing at which no customer information is required in the store terminal 40”.

In a case in which at least one of the “use of acquired customer information”, the “passage of a predetermined amount of time from the acquisition of customer information”, and the “customer's leaving of the store” is detected by the detection unit 430, it can be determined that the customer information and customer information associated with customer identification information corresponding to the customer are unnecessary. Specifically, in a case in which the “use of acquired customer information” is detected by the detection unit 430, the use of the customer information has been completed. Accordingly, it can be determined that the customer information is unnecessary. In addition, in a case in which certain customer information has not been used even if a predetermined amount of time (for example, an average amount of time for use of customer information) has passed, it can be determined that the likelihood that the customer information will be used later is low. Therefore, in a case in which the “passage of a predetermined amount of time from the acquisition of customer information” is detected by the detection unit 430, it can be determined that the customer information is unnecessary. In addition, in a case in which the customer has left the store, it can be said that the likelihood that the customer information of the customer will be used later is low. Therefore, in a case in which the “customer's leaving of the store” is detected by the detection unit 430, it can be determined that customer information associated with the customer identification information corresponding to the customer is unnecessary.

Then, the execution unit 440 executes predetermined processing on the customer information, which has been determined to be unnecessary, based on the detection results of the detection unit 430. Hereinafter, predetermined processing on customer information, which is executed by the execution unit 440, will be illustrated. However, the predetermined processing is not limited to the example shown below.

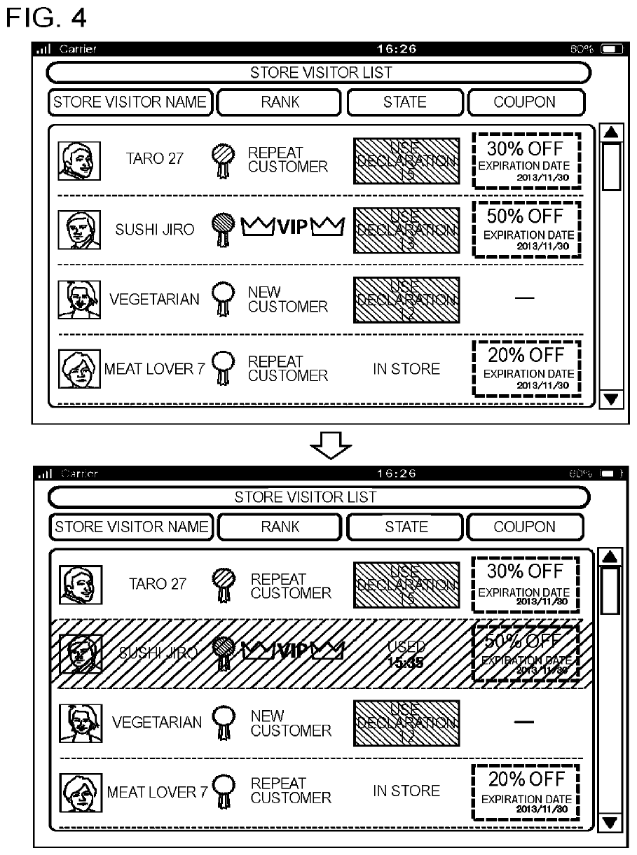

In one example, the store terminal 40 further includes a display processing unit (not shown) that displays customer information, and the execution unit 440 changes the display of customer information based on the detection result of the detection unit 430. In this case, “changing the display of customer information based on the detection result of the detection unit 430” corresponds to the predetermined processing. Specifically, the display of customer information that is determined to be “unnecessary” based on the detection result of the detection unit 430 is changed as shown in FIG. 4. FIG. 4 is a diagram illustrating a specific operation example of the execution unit 440. In FIG. 4, a screen (display processing unit) to list the customer information (coupon information) acquired from the customer information management device 10 is illustrated. The customer information displayed by the display processing unit and the display method thereof are not limited to the example shown in FIG. 4.

On the upper screen shown in FIG. 4, for the second customer information (coupon information) from the top, it is assumed that one of the use of customer information, the passage of a predetermined amount of time from the acquisition of customer information, and the customer's leaving has been detected by the detection unit 430. In this case, the execution unit 440 determines that the second customer information (coupon information) from the top is unnecessary based on the detection result of the detection unit 430. Then, the execution unit 440 changes the display of the second customer information (coupon information) from the top. Accordingly, since the user (clerk or the like) of the store terminal 40 can easily determine the required customer information, improvements in usability can be expected.

Although the example in which the color of customer information (coupon information) determined to be unnecessary by the execution unit 440 is changed is shown in FIG. 4, the present invention is not limited thereto as long as a change method enabling the distinction of the customer information (coupon information) determined to be unnecessary is used. For example, a specific mark may be attached to the customer information (coupon information) determined to be unnecessary, or the customer information (coupon information) determined to be unnecessary may be hidden on the display screen.

In another example, as predetermined processing, the execution unit 440 deletes the customer information based on the detection result of the detection unit 430. In this case, “deleting customer information based on the detection result of the detection unit 430” corresponds to the predetermined processing. The “deletion of customer information” referred to herein is deleting the customer information from the storage unit 420 of the store terminal 40. In this case, the execution unit 440 also deletes customer identification information associated with the customer identification information to be deleted. The store terminal 40 further includes the display processing unit described above. Accordingly, in a case in which customer information is displayed on the screen as in the example shown in FIG. 4, the deleted customer information is no longer displayed on the screen according to the timing of the deletion. Thus, if the customer information determined to be unnecessary is deleted from the storage unit 420, it is possible to limit the time to store the customer information on the store terminal 40. Accordingly, since it is possible to prevent the leakage of customer information, it is possible to ensure the security of the customer information compared with a case of constantly storing the customer information on the store terminal 40. In addition, since it is not necessary to constantly store the customer information of each customer on the store terminal 40, it is possible to save the resources of the store terminal 40.

[System Configuration]

Hereinafter, a mobile POS system including the customer information management device 10 is illustrated. However, the content of the present exemplary embodiment and each exemplary embodiment to be described below can be applied not only to the mobile POS system but also to a general POS system.

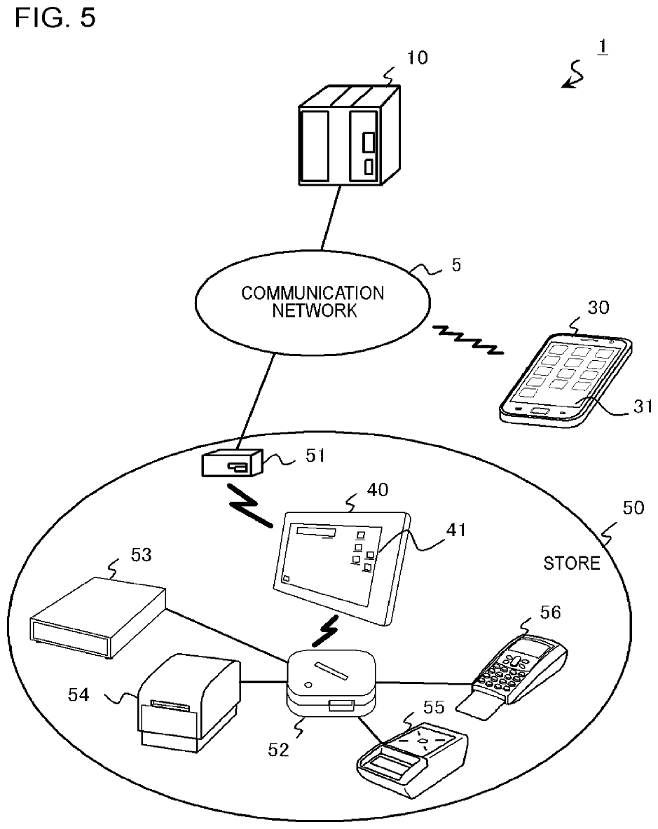

FIG. 5 is a diagram conceptually showing an example of the configuration of a mobile POS system (hereinafter, abbreviated as a POS system) in the present invention.

A POS system 1 is configured to include the customer information management device 10, a portable information terminal 30, and a store side configuration 50. The POS system 1 provides POS service for a store using the store side configuration 50. The portable information terminal 30 can also be referred to as the customer terminal 30.

The customer information management device 10 and the store side configuration 50 are communicably connected to each other through a communication network 5. The communication network 5 is formed by at least one of various forms of communication networks, such as public networks including the Internet, a wide area network (WAN), a local area network (LAN), a communication carrier network, and a wireless communication network. The implementation of the communication network 5 is not limited.

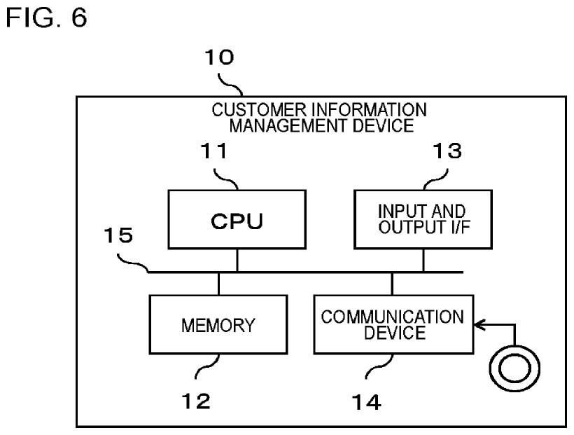

FIG. 6 is a diagram conceptually showing an example of the hardware configuration of the customer information management device 10. The customer information management device 10 is a so-called computer, and includes a central processing unit (CPU) 11, a memory 12, an input and output interface (I/F) 13, a communication device 14, and the like that are connected to each other by a bus 15, for example. The memory 12 is a random access memory (RAM), a read only memory (ROM), a hard disk, or the like. The communication device 14 communicates with other computers or other devices. A portable recording medium or the like may be connected to the communication device 14.

The input and output interface (I/F) 13 can be connected to user interface devices (not shown), such as a display device and an input device. The display device is a device that displays a screen compatible with drawing data processed by the CPU 11, a graphics processing unit (GPU; not shown), or the like, such as a liquid crystal display (LCD) or a cathode ray tube (CRT) display. The input device is a device for receiving the input of a user operation, such as a keyboard or a mouse. However, neither a display device nor an input device may be connected to the input and output I/F 13. The hardware configuration of the customer information management device 10 is not limited.

Each processing unit of the customer information management device 10 described previously is achieved, for example, by the execution of a program stored in the memory 12 by the CPU 11. For example, the program may be installed through the communication device 14 from a portable recording medium, such as a compact disc (CD) or a memory card, or other computers on the network, and may be stored in the memory 12.

The customer terminal 30 is a so-called a portable computer, such as a personal computer (PC), a mobile phone, a smartphone, or a tablet terminal. For example, the customer terminal 30 has a hardware configuration shown in FIGS. 5 and 6. According to the example shown in FIG. 6, the customer terminal 30 has, as a user interface device, a touch panel unit 31 including a display unit and a touch sensor. The display unit includes a monitor, such as a liquid crystal display (LCD) or a cathode ray tube (CRT) display, and performs display processing. A touch sensor receives an operation input from the user by sensing contact or a near contact state from the outside. However, the hardware configuration of the customer terminal 30 is not limited. For example, the user interface device of the customer terminal 30 may be a mechanical keyboard.

The store side configuration 50 includes a communication relay device 51, a store terminal 40, a stand 52, a cash drawer 53, a receipt printer 54, an electronic money reader and writer 55, and a credit card reader and writer 56. The stand 52 is a device for communicably connecting the store terminal 40 and other devices (the cash drawer 53, the receipt printer 54, the electronic money reader and writer 55, the credit card reader and writer 56, and the like) to each other. The store terminal 40 and the stand 52 are connected to each other, for example, by Bluetooth®, short-range wireless communication such as infrared communication, wireless communication such as wireless LAN, or cable communication such as a universal serial bus (USB). The stand 52 and other devices are connected to each other by various communication lines or wirelessly. The communication relay device 51 connects the store terminal 40 to the communication network 5 to enable communication between the store terminal 40 and the customer information management device 10. In addition, the form of communication between these nodes is not limited. The store terminal 40 may be connected to the communication network 5 using the 3G line through a wireless base station or the like without passing through the communication relay device 51. The cash drawer 53, the receipt printer 54, the electronic money reader and writer 55, and the credit card reader and writer 56 correspond to partial devices included in a general POS register device.

The store terminal 40 is a portable computer similar to the customer terminal 30. The store terminal 40 may be a stationary general-purpose computer similar to the customer information management device 10. For example, the store terminal 40 has a hardware configuration shown in FIGS. 5 and 6. According to the example shown in FIG. 6, the store terminal 40 has, as a user interface device, a touch panel unit 41 including a display unit and a touch sensor. However, the hardware configuration of the store terminal 40 is not limited. For example, the user interface device of the store terminal 40 may be a mechanical keyboard.

Each processing unit of the store terminal 40 described previously is achieved, for example, by the execution of a program stored in the memory 12 by the CPU 11. For example, the program may be installed through the communication device 14 from a portable recording medium, such as a CD or a memory card, or other computers on the network, and may be stored in the memory 12.

### Operation Example

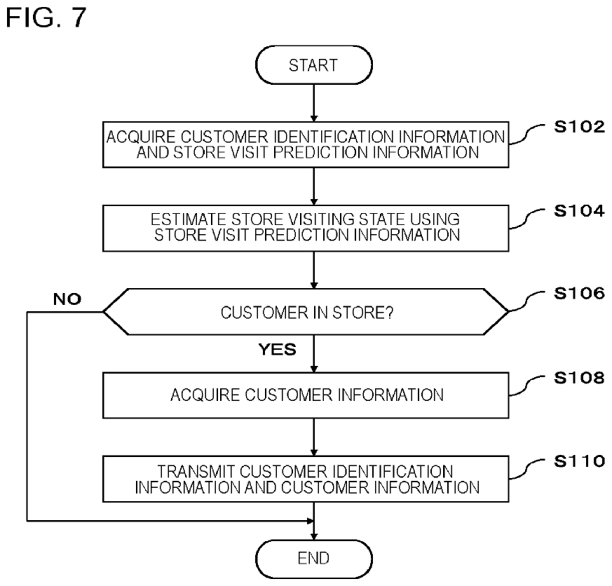

An example of the operation of the customer information management device 10 in the present exemplary embodiment will be described with reference to FIG. 7. FIG. 7 is a flowchart showing the flow of the process of the customer information management device 10 in the first exemplary embodiment.

The customer information management device 10 acquires customer identification information and store visit prediction information (S102). The customer information management device 10 can acquire the store visit prediction information and the customer identification information so as to be linked to each other as described above. Then, using the store visit prediction information, the customer information management device 10 estimates a store visiting state of the customer identified by the customer identification information acquired in S102 (S104). In a case in which the visit of the customer is estimated in S104 (S106: YES), the customer information management device 10 acquires customer information relevant to the customer identified by the customer identification information acquired in S102, from the customer information storage unit 20 (S108), and transmits the acquired customer information to the store terminal 40 together with the customer identification information of the customer (S110). On the other hand, in a case in which the visit of the customer is not estimated in S104 (S106: NO), the customer information management device 10 ends the process.

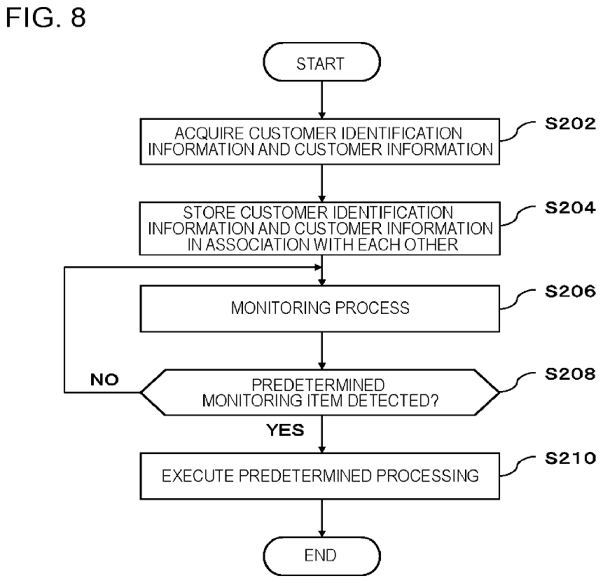

Next, an example of the operation of the store terminal 40 in the present exemplary embodiment will be described with reference to FIG. 8. FIG. 8 is a flowchart showing the flow of the process of the store terminal 40 in the first exemplary embodiment.

The store terminal 40 acquires the customer identification information and the customer information that are transmitted from the customer information management device 10 (S202). Then, the store terminal 40 stores the customer identification information and the customer information, which have been acquired in S202, in a storage region, such as a memory or a hard disk, in association with each other (S204). Then, the store terminal 40 monitors whether or not any of predetermined monitoring items (use of acquired customer information, passage of a predetermined amount of time from the acquisition of customer information, and a customer's leaving of the store) has been detected (S206). In a case in which none of the predetermined monitoring items is detected (S208: NO), the store terminal 40 continues the monitoring process (S206). On the other hand, in a casein which any of the predetermined monitoring items has been detected (S208: YES), the store terminal 40 determines the customer information, for which the monitoring item has been detected, to be unnecessary customer information, and executes predetermined processing (S210). Specifically, as the predetermined processing, the store terminal 40 executes processing for changing the display of customer information determined to be unnecessary, processing for deleting the customer information determined to be unnecessary, or the like as shown in the example described above.

[Operations and Effects of the First Exemplary Embodiment]

As described above, in the present exemplary embodiment, the store visiting state of each customer is estimated, and customer information regarding the customer is transmitted to the store terminal 40 from the customer information management device 10 at the timing corresponding to the store visiting state together with customer identification information that enables the identification of the customer.

Thus, according to the present exemplary embodiment, the “timing at which a possibility that the customer information is required in the store terminal 40 becomes high to a certain degree” is estimated, and the customer information is transmitted to the store terminal 40 at this timing. Accordingly, the store terminal 40 can be set to have already acquired information required for customer service at the time of customer service. Therefore, at the time of customer service, even if communication between the store terminal 40 and the customer information management device 10 fails, the user (clerk) of the store terminal 40 can smoothly perform operations (cash register work, coupon processing, and the like). In the present exemplary embodiment, all pieces of customer information does not need to be stored in advance in the store terminal 40, and the customer information does not need to be continuously stored. Therefore, according to the present exemplary embodiment, it is possible to reduce the memory capacity of the store terminal 40 and to shorten the storage time in the store terminal 40 of customer information that is likely to include personal information that needs to be carefully handled.

### Second Exemplary Embodiment

The present exemplary embodiment is the same as the first exemplary embodiment except for the following points.

The store visit estimation unit 110 of the present exemplary embodiment estimates one of the first store visiting state and the second store visiting state as a store visiting state. Here, the “first store visiting state” indicates a state in which the customer is visiting the store, and the “second store visiting state” indicates a state in which the customer has not yet visited the store but will visit the store later.

The store visit estimation unit 110 can determine the first store visiting state and the second store visiting state using the store visit certainty degree score linked to the store visit prediction information, for example. In this case, a first threshold value for determination of the first store visiting state and a second threshold value for determination of the second store visiting state are set in advance. The store visit estimation unit 110 estimates a store visiting state by comparing the sum of the store visit certainty degree scores, which are linked to one or more pieces of the acquired store visit prediction information, with the first and second threshold values. In addition, the store visit estimation unit 110 may estimate the store visiting state by comparing the number of pieces of the acquired store visit prediction information or the number of types of the acquired store visit prediction information with the first and second threshold values.

Then, the customer information transmission unit 120 of the present exemplary embodiment determines the transmission timing of customer identification information and customer information based on the store visiting state estimated by the store visit estimation unit 110. Specifically, in a case in which the store visiting state estimated by the store visit estimation unit 110 is the “first store visiting state”, the customer information transmission unit 120 transmits customer information regarding the customer identified by the customer identification information to the store terminal 40 at the estimation timing of the first store visiting state. On the other hand, in a case in which the store visiting state estimated by the store visit estimation unit 110 is the “second store visiting state”, there is a time lag until the customer actually visits the store. Therefore, the customer information transmission unit 120 transmits the customer information regarding the customer identified by the customer identification information to the store terminal 40 after the passage of a predetermined amount of time from the estimation timing of the second store visiting state.

The “predetermined amount of time” is set to a value determined in advance by the user, for example. In addition, if the position information of the customer is acquired, the “predetermined amount of time” can also be set as a variable amount according to the distance calculated from the position information of the customer and the position information of the store.

### Operation Example

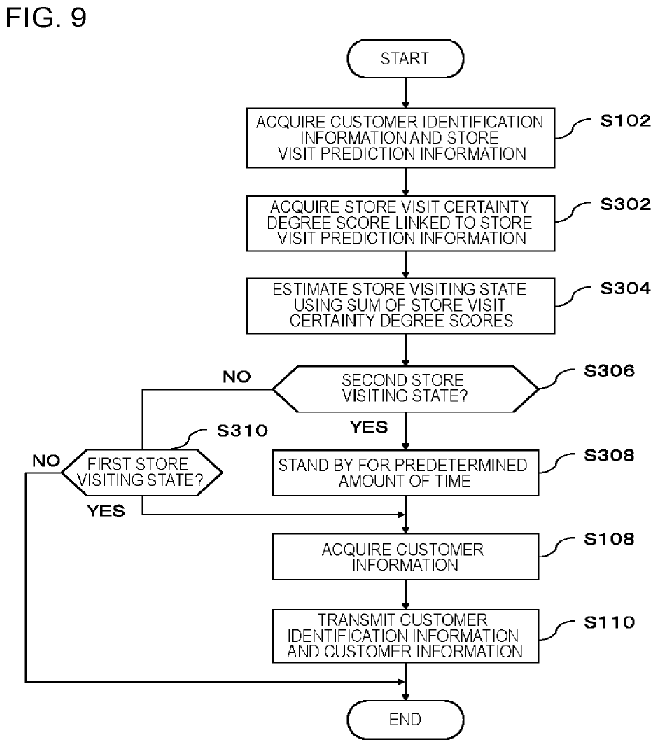

An example of the operation of the customer information management device 10 in the present exemplary embodiment will be described with reference to FIG. 9. FIG. 9 is a flowchart showing the flow of the process of the customer information management device 10 in a second exemplary embodiment. Hereinafter, different steps (S302) to (S310) from the first exemplary embodiment will be described.

The customer information management device 10 acquires a store visit certainty degree score linked to the store visit prediction information acquired in S102 (S302). Here, in a case in which a plurality of pieces of store visit prediction information acquired in S102 are present, the customer information management device 10 acquires a store visit certainty degree score linked to each piece of the store visit prediction information. Then, the customer information management device 10 calculates a sum of the store visit certainty degree scores acquired in S302, and estimates a store visiting state using the calculated sum of the store visit certainty degree scores (S304). Specifically, as described above, it is estimated whether the store visiting state is the “first store visiting state” or the “second store visiting state” by comparing the calculated sum of the store visit certainty degree scores with the first and second threshold values. In a case in which the store visiting state estimated in S304 is the “second store visiting state” (S306: YES), the customer information management device 10 stands by for a predetermined amount of time (S308). Then, after the passage of the predetermined amount of time, the customer information management device 10 acquires customer information (S108), and transmits the customer identification information and the customer information to the store terminal 40 (S110).

On the other hand, in a case in which the store visiting state estimated in S304 is not the “second store visiting state” (S306: NO), the customer information management device 10 determines whether or not the store visiting state is the “first store visiting state”. In a case in which the store visiting state is the “first store visiting state” (S310: YES), the customer information management device 10 acquires customer information without standing by for a predetermined amount of time (S108), and transmits the customer identification information and the customer information to the store terminal 40 (S110). On the other hand, in a case in which the store visiting state is not the “first store visiting state” (S310: NO), the customer information management device 10 ends the process.

[Operations and Effects of the Second Exemplary Embodiment]

As described above, in the present exemplary embodiment, two store visiting states of the “first store visiting state” and the “second store visiting state” are estimated based on the store visit certainty degree score linked to the store visit prediction information, and the transmission timing of customer information is determined according to the estimated store visiting state. Therefore, according to the present exemplary embodiment, it is possible to transmit the customer information to the store terminal at a more appropriate timing.

### Third Exemplary Embodiment

The present exemplary embodiment is the same as the first and second exemplary embodiments except for the following points.

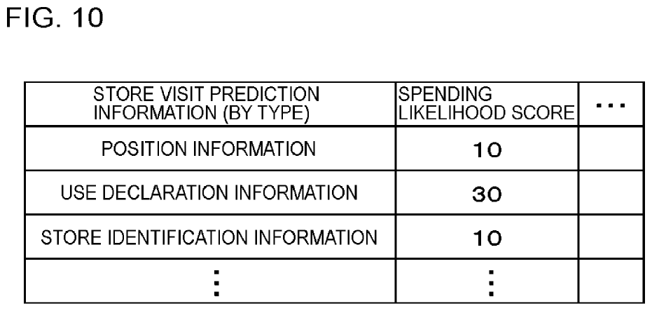

In the present exemplary embodiment, each type of the store visit prediction information has a spending likelihood score linked thereto, and the customer information transmission unit 120 selects the type of customer information to be transmitted using the spending likelihood score. Here, the “spending likelihood score” is an index value indicating the likelihood of spending by the customer. For example, the “spending likelihood score” may be expressed with a simple numerical value as shown in FIG. 10, or may be expressed with a probability. FIG. 10 is a diagram showing an example of the spending likelihood scores. As shown in FIG. 10, the type of store visit prediction information and the spending likelihood score corresponding to the type of the store visit prediction information are linked to each other. In the example shown in FIG. 10, from the use declaration information indicating the intention to use a coupon, the likelihood of the determination that the customer will make a payment is high. Accordingly, the score is set to be high. On the other hand, in the other pieces of store visit prediction information, there may be cases of simply passing nearby or visiting the store for just window shopping. Accordingly, the score is set to be low. FIG. 10 is only an example, and the setting of the spending likelihood score is not limited to FIG. 10.

In the present exemplary embodiment, the customer information transmission unit 120 calculates a sum of spending likelihood scores linked to one or more pieces of store visit prediction information acquired by the customer information management device 10, and selects the type of customer information to be transmitted using the calculated sum of the spending likelihood scores. Specifically, the customer information transmission unit 120 determines whether or not to acquire customer information with a high degree of importance according to the likelihood of spending indicated by the spending likelihood score. The “customer information with a high degree of importance” is authentication data used in personal authentication in a credit card payment, for example. In view of the problem of privacy and the like, the time for the storage of the information with a high degree of importance, such as authentication data used in personal authentication, is preferably set as short as possible. Here, in a case in which the payment has been made by the customer, that customer information relevant to the customer can be determined as unnecessary, and the customer information regarding the customer can be deleted. Therefore, by transmitting the customer information with a high degree of importance to the store terminal 40 when the likelihood of spending of the customer is equal to or greater than a predetermined value, it is possible to shorten the time for storing the customer information with a high degree of importance in the store terminal 40 more than necessary. Therefore, the customer information transmission unit 120 of the present exemplary embodiment determines the likelihood of spending of the customer using the spending likelihood score, and determines whether or not to acquire customer information with a high degree of importance.

### Operation Example

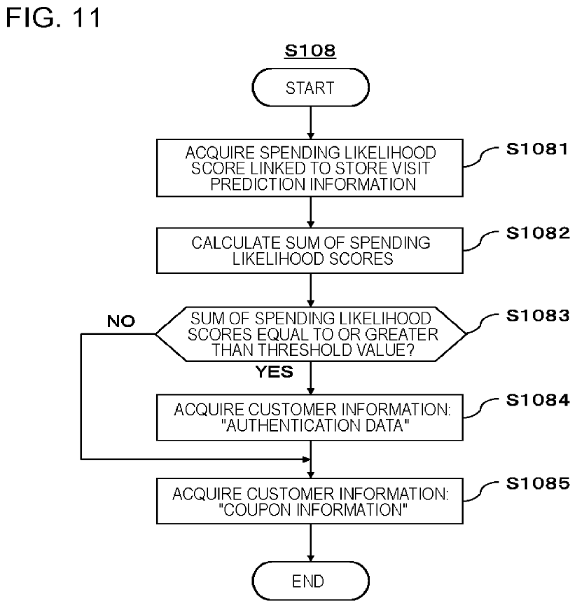

An example of the operation of the customer information management device 10 in the present exemplary embodiment will be described with reference to FIG. 11. FIG. 11 is a flowchart showing the flow of the process of the customer information management device 10 in a third exemplary embodiment. In addition, FIG. 11 shows the flow of the detailed process of S108.

The customer information management device 10 acquires a spending likelihood score linked to the store visit prediction information acquired in S102 (S1081). Here, in a case in which a plurality of pieces of store visit prediction information acquired in S102 are present, the customer information management device 10 acquires a spending likelihood score linked to each piece of the store visit prediction information. Then, the customer information management device 10 calculates a sum of the spending likelihood scores acquired in S1081 (S1082), and determines whether or not the calculated sum of the spending likelihood scores is equal to or greater than a predetermined threshold value (S1083). In a case in which the calculated sum of the spending likelihood scores is equal to or greater than the predetermined threshold value S1082 (S1083: YES), the customer information management device 10 acquires customer information whose type is “authentication data” (S1084). In addition, the customer information management device 10 acquires customer information whose type is “coupon information” (S1085). On the other hand, in a case in which the sum of the spending likelihood scores calculated in S1082 is less than the predetermined threshold value (S1083: NO), the customer information management device 10 acquires only the customer information whose type is “coupon information” without acquiring the customer information whose type is “authentication data” (S1085).

[Operations and Effects of the Third Exemplary Embodiment]

As described above, in the present exemplary embodiment, customer information to be acquired is selected based on the spending likelihood score linked to the store visit prediction information. Thus, according to the present exemplary embodiment, since it is possible to shorten the time for which information with a high degree of importance is stored in the store terminal 40 more than necessary, it is possible to prevent leakage of customer information more accurately. Therefore, it is possible to ensure higher security of customer information.

Hereinafter, the above content will be more specifically described by way of an example below. However, the present invention is not at all limited to the following example. In the following example, the flow of the credit card payment process including customer authentication using authentication data, which is executed on a POS system, is illustrated. In the following example, the authentication data is biometric data (data including the feature amount of the face, fingerprint, and vein). In addition, in the following example, an example of performing personal authentication using face recognition technology using biometric data relevant to a face is shown.

### Examples

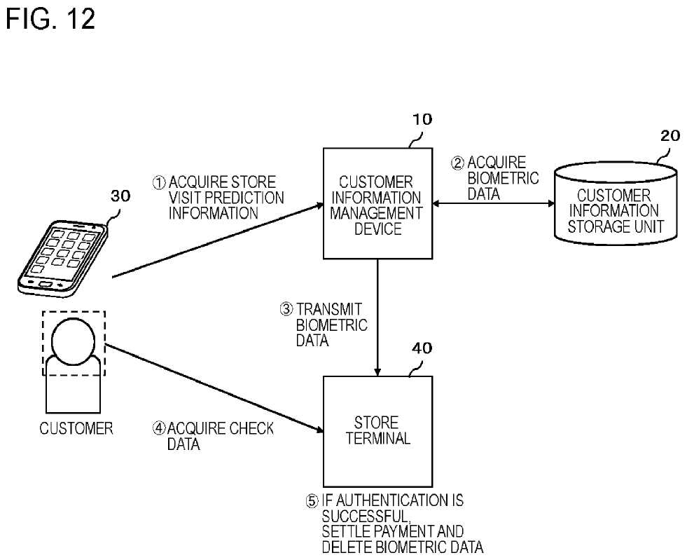

FIG. 12 is a diagram showing the configuration of a POS system and the flow of the process in the example of the present invention. The flow of the process shown in the example of FIG. 12 is as follows.

First, the customer information management device 10 acquires store visit prediction information, such as position information and use declaration information, from the customer terminal 30. Then, the customer information management device 10 estimates the visit of a customer based on the acquired store visit prediction information, and acquires the biometric data of the customer from the customer information storage unit 20. Then, the customer information management device 10 transmits the biometric data, which is acquired at the timing of the estimation of the visit of the customer, to the store terminal 40. Accordingly, the store terminal 40 is in a state in which the biometric data has already been acquired when the customer makes a payment.

Then, when the customer actually makes a payment, the store terminal 40 acquires data for collation for performing face recognition by capturing a face image of the customer using an imaging apparatus provided in the store terminal 40 or the like. Then, the store terminal 40 performs customer authentication by comparing the data for collation with the biometric data acquired from the customer information management device 10. In a case in which the customer has been successfully authenticated, the store terminal 40 performs payment processing by credit card by accessing other servers, and deletes the biometric data that has become unnecessary after the completion of payment.

Thus, according to the present invention, customer information relevant to the business does not need to be stored in advance or continuously in the store terminal 40. Therefore, according to the present invention, it is possible to reduce the terminal resources, such as the memory capacity of the store terminal 40. This is particularly effective in a mobile POS system in which an inexpensive terminal can be used as the store terminal 40 since a number of processes are executed on the server. In addition, according to the present invention, the storage time of the customer information (for example, biometric data) including personal information that needs to be carefully handled in the store terminal 40 is shortened. Therefore, it is possible to ensure security of customer information by reducing the likelihood that the customer information including the personal information will be leaked from the store terminal 40.

While the exemplary embodiments of the present invention have been described with reference to the diagrams, these are only illustrations of the present invention, and other various configurations can also be adopted.

In a plurality of flowcharts used in the above explanation, a plurality of steps (processes) are described in order. However, the execution order of the processes performed in each exemplary embodiment is not limited to the described order. In each exemplary embodiment, it is possible to change the order of the illustrated steps in a range in which no problem is caused in terms of the content. In addition, the respective exemplary embodiments described above can be combined in a range in which the contents do not conflict.

What is claimed is:

1. A display device comprising:
a display; and
a processor configured to:
estimate, based on prediction information enabling a prediction of a visiting state and identification information enabling unique identification of a person, the visiting state of the person identified by the identification information, and
transmit, at a time when the person is estimated to visit a location based on the estimated visiting state of the person, the identification information to a terminal, wherein the identification information comprises authentication data for personal authentication of the person identified by the identification information.

2. The display device of claim 1, wherein the prediction information includes at least one from among position information of the person and location identification information for identifying a location that the person is visiting.

3. A method for controlling a display device, the method comprising:
estimating, based on prediction information enabling a prediction of a visiting state and identification information enabling unique identification of a person, the visiting state of the person identified by the identification information, and
transmitting, at a time when the person is estimated to visit a location based on the estimated visiting state of the person, the identification information to a terminal, wherein the identification information comprises authentication data for personal authentication of the person identified by the identification information.

4. The method of claim 3, wherein the prediction information includes at least one from among position information of the person and location identification information for identifying a location that the person is visiting.

5. A non-transitory computer readable medium storing a program causing a computer to perform:
estimating, based on prediction information enabling a prediction of a visiting state and identification information enabling unique identification of a person, the visiting state of the person identified by the identification information, and
transmitting, at a time when the person is estimated to visit a location based on the estimated visiting state of the person, the identification information to a terminal, wherein the identification information comprises authentication data for personal authentication of the person identified by the identification information.

6. The non-transitory computer readable medium of claim 5, wherein the prediction information includes at least one from among position information of the person and location identification information for identifying a location that the person is visiting.
